(19) United States
(12) Patent Application Publication
(10) Pub. No.: US 2007/0182247 A1
(43) Pub. Date: Aug. 9, 2007

(54) Emergency power supply for car

(76) Inventors: Jae-Hyun Kim, Gyeonggi-do (KR); Yoon-Hyeok Kwon, Gyeonggi-do (KR)

Correspondence Address: JONES DAY, 222 EAST 41ST ST, NEW YORK, NY, 10017, US

(21) Appl. No.: 11/650,060

(22) Filed: Jan. 4, 2007

(30) Foreign Application Priority Data
Jan. 5, 2006 (KR) 10-2006-0001274

(51) Int. Cl. B60L 1/00

(52) U.S. Cl. 307/10.1

(57) ABSTRACT

An emergency power supply for a car may supply power to a car in an emergency by using a human power. The emergency power supply includes a manual power generator for generating a power; a charging circuit for controlling a power received from the manual power generator to convert the power into a power required for charging capacitors; a capacitor unit provided with a plurality of capacitors to store the energy applied from the charging circuit into the capacitors; and a connector for connecting the capacitor unit to the car battery. This emergency power supply may generate an emergency power using human power without requiring any complex machine, and it may be substantially permanently used without any maintenance of its energy storage.

### BACKGROUND OF THE INVENTION

1. Field of the Invention

The present invention relates to an emergency power supply for a car, and more particularly to an emergency power supply for a car, which may supply power to a car in an emergency by using a human power.

2. Description of the Related Art

Generally, power consumed in various electronic devices mounted to a car is supplied through a battery. This battery is continuously charged by means of a power generator connected to the engine while the car is running, so it may be used substantially permanently.

However, if the battery is left alone with turning on any electric device of a car such as an indoor lamp or an indication lamp due to the carelessness of a driver, the battery may be completely discharged not to start the car. In this case, the user generally connects the discharged battery to a battery of another car (that is a not-discharged battery) using an extension line so as to supply power required for starting the car. As a result, it is difficult to start a car having a discharged battery without a help of another car.

In order to solve this problem, Korean Laid-open Patent Publication No. 10-2004-0029515 discloses an emergency start-up device, which may be used when a battery of a car is completely discharged. Specifically, referring to FIG. 1, the emergency start-up device repeatedly operates a clutch pedal 2 by means of manual manipulation of a driver so that oil in an oil reservoir tank 6 is moved to a hydraulic pump 18 through a second oil passage 10. Then, a hydraulic motor 22 is rotated by means of the pumping operation of the hydraulic pump 18. In addition, a starting gear 26 connected to the hydraulic motor 22 transfers a rotational force to a flywheel 28. As a result, an engine is driven by means of the rotational force of the flywheel 28 to start the car. This emergency start-up device may start a car when the battery for the car is completely discharged. However, in order to forcibly operate the flywheel using the hydraulic pump, very complex machines are required.

Meanwhile, Korean Laid-open Patent Publication No. 10-2005-004110 discloses an emergency start-up power supply for a car, which employs a dry cell. Referring to FIG. 2, the emergency start-up power supply 50 has two 9V dry cells 54 inserted into a dry cell insert 56 in a case 55. In addition, the emergency start-up power supply 50 includes a serial wiring 52 for serially connecting the two dry cells, and an external wiring 51 drawn out from electrodes of the dry cells 54, which are not connected by the serial wiring 52.

However, the dry cell 54 used in the emergency start-up power supply 50 should have a great capacity so as to drive a start motor of a car. Thus, there are problems that the dry cell 54 used in the emergency start-up power supply 50 has a great volume and requires continuous maintenance.

### SUMMARY OF THE INVENTION

The present invention is designed to solve the problems of the prior art, and therefore it is an object of the present invention to provide a device, which may generate a predetermined electric energy using a human power, store the generated electric energy in an ultra capacitor, and also supply the power to a car in an emergency.

In order to accomplish the above object, the present invention provides an emergency power supply for a car, which connected to a car battery, the emergency power supply including a manual power generator for generating a power; a charging circuit for controlling a power received from the manual power generator to convert the power into a power required for charging capacitors; a capacitor unit provided with a plurality of capacitors to store the energy applied from the charging circuit into the capacitors; and a connector for connecting the capacitor unit to the car battery.

Preferably, the capacitor unit includes a balancing circuit for balancing charged voltages of the capacitors; and an output circuit for outputting the energy stored in the capacitors together.

The output circuit preferably includes a circuit for preventing a reverse connection.

The capacitor unit may further include a switching means capable of selectively connecting the balancing circuit and the output circuit.

Preferably, the connector is a cigar jack connected to the car battery.

The manual power generator may be a DC power generator or an AC power generator.

### BRIEF DESCRIPTION OF THE DRAWINGS

Other objects and aspects of the present invention will become apparent from the following description of embodiments with reference to the accompanying drawing in which:

FIG. 1 is a schematic diagram showing an emergency start-up device according to the prior art;

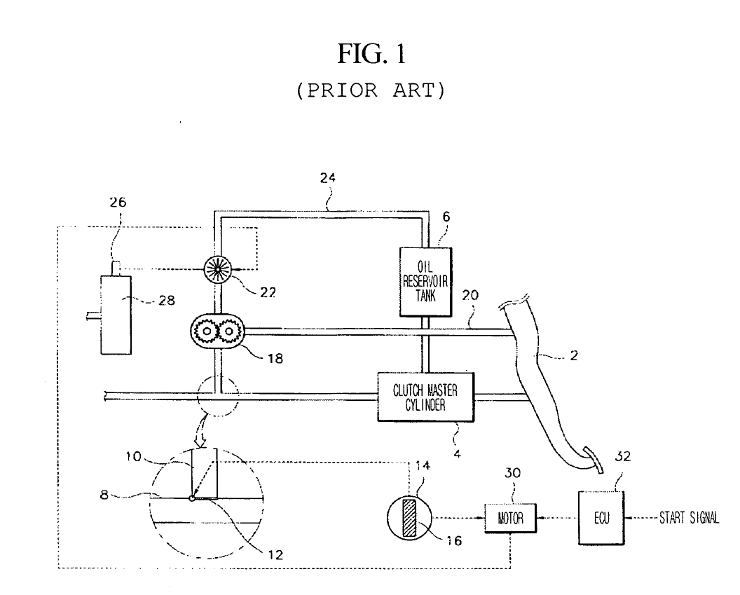

FIG. 2 is a sectional view showing a power supply for emergency start-up according to the prior art; and

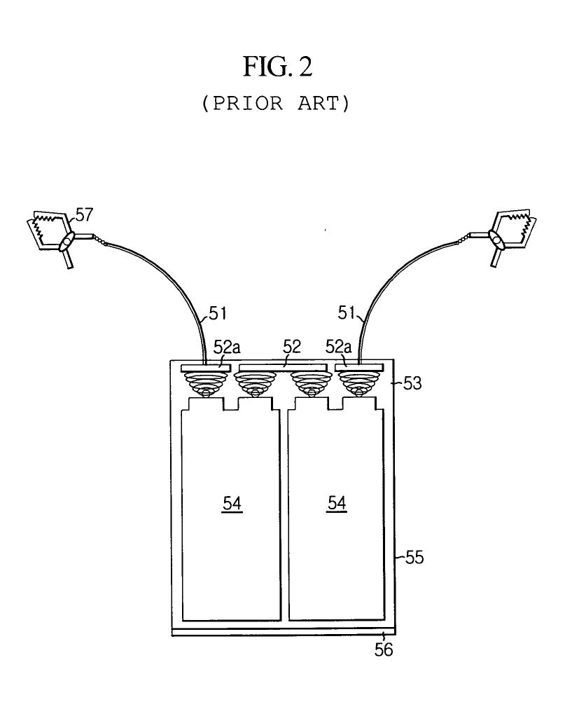

FIG. 3 is a block diagram showing an emergency power supply for a car according to a preferred embodiment of the present invention.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

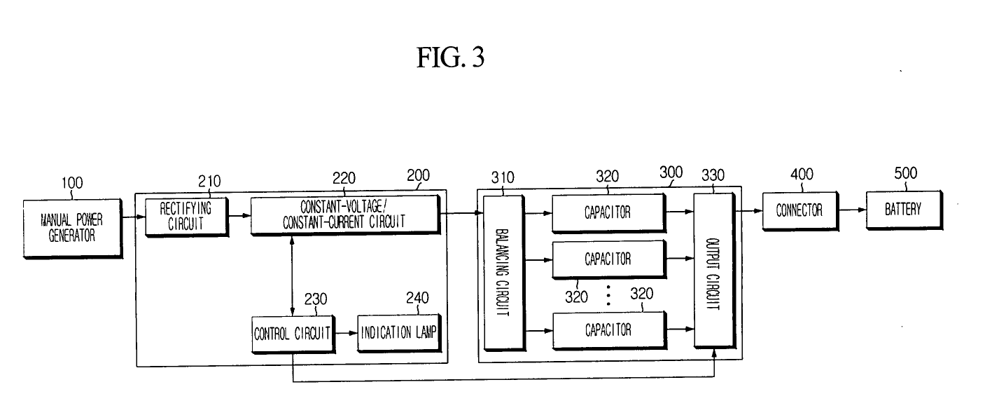

FIG. 3 is a detailed block diagram showing an emergency power supply for a car according to a preferred embodiment of the present invention. Referring to FIG. 3, the emergency power supply for a car according to this embodiment includes a manual power generator 100, a charging circuit 200, and a capacitor unit 300, and a connector 400.

The manual power generator 100 has a common power generator structure, which includes a housing, a magnet mounted and rotated in the housing, a power generating coil fixed to an inner side of the housing to surround the magnet. A rotary shaft is provided to the center of the magnet, and one end of the rotary shaft is extended and exposed out of the housing for the purpose of manual rotation by a human power. A rotating handle is coupled to the extended and exposed rotary shaft for the purpose of manual rotation.

The charging circuit 200 converts an alternative current applied from the manual power generator 100 into a direct current required for charging capacitors, and then applies it to the capacitor unit 300.

The capacitor unit 300 receives the direct current from the charging circuit 200 and then stores it as an energy required for charging a car battery 500.

The connector 400 acts for electrically connecting an output terminal of the capacitor unit 300 to an input terminal of the car battery 500.

Preferably, the connector 400 is a cigar jack commonly provided to the car so as to prevent any short circuit occurring by contact between a battery terminal and a metal car body.

In this embodiment, the connector 400 is exemplarily explained as a cigar jack. However, the present invention is not limited thereto. Thus, the connector 400 may adopt any configuration capable of electrically connecting the output terminal of the capacitor unit 300 to the terminal of the car battery 500.

Hereinafter, the charging circuit 200 and the capacitor unit 300 will be described in more detail.

First, the charging circuit 200 includes a rectifying circuit 210, a constant-voltage/constant-current circuit 220, a control circuit 230 and an indication lamp 240.

The rectifying circuit 210 converts an alternative current input from the manual power generator 100 into a direct current. In addition, the rectifying circuit 210 rectifies it into a direct current of a certain level and then transmits it to the constant-voltage/constant-current circuit 220.

The constant-voltage/constant-current circuit 220 supplies a charging power to the capacitor unit 300 in a constant-voltage/constant-current mode. That is to say, at an initial charging point of the capacitor unit 300, the constant-current mode is kept, and then, if the charged voltage of the capacitor unit 300 is saturated, it is shifted into a constant-voltage mode.

The control circuit 230 is a kind of microprocessor, which monitors a charged current and a charged voltage and then controls the constant-voltage/constant-current circuit 220 accordingly so as to shift the constant-voltage mode and the constant-current mode suitably.

In addition, if the control circuit 230 determines that the charging process is completed while monitoring a charged voltage of the capacitor unit 300, the control circuit 230 turns on the indication lamp 240 and then informs a user that the capacitor unit 300 is completely charged.

The capacitor unit 300 includes a balancing circuit 310, a plurality of capacitors 320, and an output circuit 330.

The balancing circuit 310 balances a charged power distributed to each capacitor 320 so that the charged power input from the charging circuit 200 may be uniformly charged to each capacitor 320.

The capacitor 320 receives the charged power and stores it as an electric energy. Preferably, the capacitor 320 is an EDLC (Electric Double Layer Capacitor) capable of storing a large amount of charged energy, but not limited thereto.

The output circuit 330 connects electrodes provided to the plurality of capacitors 320 in series and emits the charged power to outside through a pair of electrodes (+, −).

In case the electrodes (+, −) provided to the output circuit 330 are reversely connected to the terminals of the car battery, the energy stored in the plurality of capacitors 320 may be completely discharged. Thus, it is preferred that the output circuit 330 is provided with a circuit capable of preventing a reverse connection.

Charging and discharging of the capacitor 320 are conducted through the pair of electrodes (+, −). Thus, the capacitor unit 300 preferably further includes a switch (not shown) capable of selectively connecting the balancing circuit 310 and the output circuit 330. The switch selectively connects the electrodes (+, −) of the capacitor 320 to the balancing circuit 310 or the output circuit 330 by means of the operation of the control circuit 230.

Hereinafter, the operation of the emergency power supply for a car according to the embodiment of the present invention will be described with reference to the above components.

First, the manual power generator 100 is operated by means of manual manipulation to generate an induced alternating current.

The generated induced alternating current is converted into a direct current of a certain level by means of the rectifying circuit 210 and then output. The direct current output from the rectifying circuit 210 is applied to the balancing circuit 310 through the constant-voltage/constant-current circuit 220. At this time, the control circuit 230 ordinarily monitors an output voltage and an output current of the constant-voltage/constant-current circuit 220 to control a driving mode (the constant-voltage mode or the constant-current mode). In addition, the control circuit 230 detects a charging state of the capacitor unit 300 with reference to the monitored voltage and current values. Then, the control circuit 230 outputs the charging state by means of the indication lamp or the like.

After that, the balancing circuit 310 distributes the applied charged power in consideration of the charging state of the capacitors 320 so that the capacitors 320 may keep their charging voltages identically.

If all of the capacitors 320 are completely charged and thus the current applied from the constant-voltage/constant-current circuit 220 to the balancing circuit 310 is reduced, the control circuit 230 detects it and then interrupts a connection between the balancing circuit 310 and the capacitors 320. Then, the control circuit 230 connects the output circuit 330 to the capacitors 320.

If the battery is completely discharged, the connector 400 is connected to the battery. Then, the charged energy stored in the plurality of capacitors 320 is applied to the battery 500 through the output circuit 330. If starting the car in this state, the start motor rotates by means of the energy stored in the capacitor unit 300, and as a result the car is started.

In the embodiment of the present invention, an AC power generator is exemplarily explained as the manual power generator 100. In this consideration, the rectifying circuit 210 for converting an alternative current into a direct current is provided to the charging circuit 200. However, a DC power generator may be adopted as an alternative of the AC power generator. In this case, the rectifying circuit 210 provided to the charging circuit 200 may be excluded.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, it is possible to generate an emergency power using human power without any complex machine by employing the manual power generator.

In addition, since an energy is stored in and used from the EDLC (Electric Double Layer Capacitor) with excellent electric energy storing ability, the emergency power supply of the present invention may be used substantially permanently without requiring any further energy storage.

In addition, since the EDLC having a small size is used as an energy storage, it is possible to realize a lightweight emergency power supply.

What is claimed is:

1. An emergency power supply for a car, which connected to a car battery, the emergency power supply comprising:
a manual power generator for generating a power;
a charging circuit for controlling a power received from the manual power generator to convert the power into a power required for charging capacitors;
a capacitor unit provided with a plurality of capacitors to store the energy applied from the charging circuit into the capacitors; and
a connector for connecting the capacitor unit to the car battery.

2. The emergency power supply for a car according to claim 1, wherein the capacitor unit includes:
a balancing circuit for balancing charged voltages of the capacitors; and
an output circuit for outputting the energy stored in the capacitors together.

3. The emergency power supply for a car according to claim 2,
wherein the output circuit includes a circuit for preventing a reverse connection.

4. The emergency power supply for a car according to claim 2,
wherein the capacitor unit further includes a switching means capable of selectively connecting the balancing circuit and the output circuit.

5. The emergency power supply for a car according to claim 1,
wherein the connector is a cigar jack connected to the car battery.

6. The emergency power supply for a car according to claim 1,
wherein the manual power generator is a DC power generator or an AC power generator.
